(19) United States
(12) Patent Application Publication
(10) Pub. No.: US 2009/0120409 A1
(43) Pub. Date: May 14, 2009

(54) Engine speed control apparatus

(75) Inventors: Umerujan Sawut, Kanagawa-ken (JP); Shinya Yamaguchi, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi (JP)

(21) Appl. No.: 12/222,990

(22) Filed: Aug. 21, 2008

(30) Foreign Application Priority Data
Nov. 12, 2007 (JP) 2007-292704

(51) Int. Cl. F02D 11/10

(52) U.S. Cl. 123/399

(57) ABSTRACT

The invention achieves a good engine speed control without increasing a cost and a lowering a reliability of an apparatus in a general purpose engine. In a rotating speed control apparatus of an engine in which an electronic control unit (10) controls an engine speed by operating so as to open and close a throttle valve (40) by an electronic governor apparatus (4) on the basis of an engine speed detected by a crank angle sensor (7) corresponding to an engine speed detecting means and regulating an intake air amount, the opening and closing operation of the throttle valve (40) in the electronic governor apparatus (4) is carried out by a rotating force of a motor rotationally driven only in one direction and an elastic repulsive force of a return spring energizing in a reverse direction.

### BACKGROUND OF THE INVENTION

1. Field of the Invention

The present invention relates to an engine speed control apparatus of a general purpose engine.

2. Description of Related Art

Conventionally, as described in Japanese Unexamined Patent Publication No. 4-116256, there has been in widespread an electronic governor in which an engine speed is maintained at a predetermined speed by controlling a throttle valve opening degree by an electronic control means via a motor-driven actuator.

An engine speed control by the electronic governor mentioned above is carried out by feedback processing a detected signal of the engine speed (the rotating speed) and driving a motor controlling an angle of a throttle valve, however, since the motor controls a throttle angle position on the basis of a feedback signal, it is necessary to carry out a forward rotation and a reverse rotation in the driving operation of the motor.

Accordingly, both driving circuits for the forward rotation and the reverse rotation are necessary as a drive circuit of the motor. For example, in the case of a direct-current motor, since four power semiconductors and a circuit switching the normal rotation and the reverse rotation are normally necessary as the drive circuit, the apparatus becomes complicated. Further, since a throttle angle sensor is necessary for controlling the throttle angle in addition to the sensor for detecting the engine speed, a lot of these parts come to a problem on cost in the general purpose engine in which a low cost is demanded.

On the other hand, in the rotating speed control of the general purpose engine by the electronic governor mentioned above, the electronic control apparatus constructing a part of the electronic governor generally PID controls a command value output to a step motor or the like corresponding to an actuator, however, in the case that a characteristic of a controlled object is changed in the control system mentioned above in which a lot of nonlinear elements exist, the control system tends to run into a state in which the control can not be sufficiently carried out.

Then, the invention in which a robust control is executed in correspondence to the change of the characteristic of the engine speed corresponding to the controlled object is proposed in Japanese Unexamined Patent Publication No. 2003-231424. If this control method is used, it is possible to carry out an accurate correspondence even in the case that the characteristic of the controlled object is changed, and it is possible to maintain the engine speed at a desired level. However, the sensors and the drive circuit for the forward and reverse rotations mentioned above are necessary even in this technique, and the problems in the view of the cost and the reliability of the apparatus are not solved. Accordingly, this technique has not yet led to a wide spread in the general purpose engine field.

### SUMMARY OF THE INVENTION

The present invention intends to solve the problem as mentioned above, and an object of the present invention is to achieve a good engine speed control without increasing a cost and a lowering a reliability of an apparatus in a general purpose engine.

In order to achieve the object mentioned above, in accordance with the present invention, there is provided an engine speed control apparatus comprising:

an electronic control means;

a throttle valve opening and closing means;

the electronic control means controlling an engine driven by feeding an air-fuel mixture to an intake passage provided with a throttle valve and a carburetor so as to maintain a predetermined engine speed by operating to open and close the throttle valve by the throttle valve opening and closing means on the basis of an engine speed detected by an engine speed detecting means and regulating an intake air amount,

wherein the throttle valve opening and closing means is formed by a motor rotationally driving the opening and closing motion of the throttle valve only in one direction, and a return spring energizing in a reverse direction to the rotation of the motor, and the throttle valve is opened and closed on the basis of a rotating force of the motor and an elastic repulsive force of the return spring.

With regard to the throttle valve opening end closing means drivingly operated by the electronic control means controlling the engine speed, in the present invention, since it is possible to control both the motions in the opening direction and the closing direction of the throttle valve by drivingly operating the motor only in one direction by utilizing the energizing force of the return spring, the structure of the apparatus becomes simple without necessity of a lot of drive circuits for driving the motor such as the conventional one, and it is possible to achieve the low cost while easily securing a reliability.

Further, if the throttle valve opening and closing means is structured such as to carry out an angle position control of the throttle valve closing motion by the return spring as well as carrying out the opening motion of the throttle valve on the basis of a turning force in a fixed direction by the motor, it is possible to rapidly and suitably control on the basis of a comparatively simple structure and a simple processing procedure.

Further, in the engine speed control apparatus mentioned above, if the electronic control means is structured such as to execute the engine speed control in accordance with a predetermined robust sliding mode control in place of the PID control, it is easy to secure a stability and an accuracy of the control even in a servo system engine speed control in which a high robustness is demanded.

Further, in the engine speed control apparatus using the robust sliding mode control, if the feedback control is carried out by using only the engine speed data detected by the electronic control means, and the predetermined engine speed is maintained without using the throttle angle sensor, it is possible to omit the throttle angle sensor and a lower cost can be achieved.

In accordance with the present invention in which both the open and close motions of the throttle valve are controlled by driving controlling the motor only in one direction by using the return spring, it is possible to achieve a good rotating speed control in the general purpose engine, without increasing the cost and lowering the reliability of the apparatus.

### BRIEF DESCRIPTION OF THE DRAWINGS

FIG. 1 is an arrangement view showing an embodiment in accordance with the present invention;

FIG. 2A is a graph showing a result of control by an engine speed control apparatus in FIG. 1; and

FIG. 2B is a graph showing a result of control by the engine speed control apparatus in FIG. 1.

### DESCRIPTION OF PREFERRED EMBODIMENTS

A description will be given below of a best mode for carrying out the present invention with reference to the accompanying drawings.

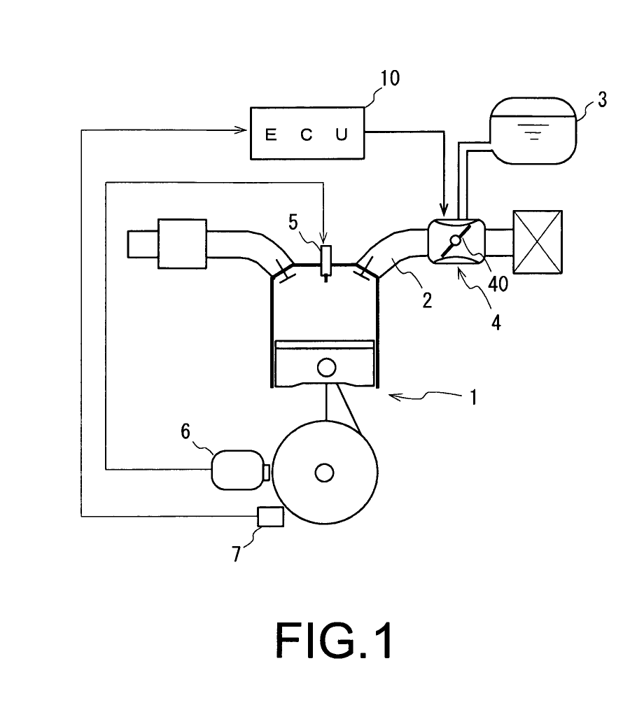

FIG. 1 shows an engine system in which an engine speed control apparatus in accordance with the present embodiment is arranged, in which an engine 1 is assumed by a general purpose engine, however, an electronic governor apparatus 4 doubling as a carburetor while being provided with a throttle valve 40 and serving as a throttle valve opening and closing means is arranged in the middle of an intake passage 2. Further, a fuel supply piping from a fuel tank 3 is connected to a carburetor part of the electronic governor apparatus 4.

On the other hand, an ignition apparatus 6 is arranged in an outer peripheral side of a flywheel of the engine 1 so as to output an ignition signal to an ignition plug 5. A crank angle sensor 7 is arranged near the ignition apparatus 6 so as to output a detection signal to an electronic control unit 10.

Accordingly, the electronic control unit 10 continuously detecting the engine speed operates so as to open and close the throttle valve 40 of the electronic governor apparatus 4 in accordance with a feedback control, thereby controlling an engine speed, and the engine speed control apparatus in accordance with the present embodiment is constructed by the electronic control unit 10 and the electronic governor apparatus 4.

A motor (not shown) is arranged as an actuator for opening and closing the throttle valve 40 in the electronic governor apparatus 4 serving as an opening and closing means of the throttle valve 40, and is drivingly controlled by the electronic control unit 10 so as to regulate a throttle angle (an opening degree). Further, the motor drives the throttle valve 40 only in a forward rotating direction actuating in an opening side, and a reverse rotating direction actuating in a closing side is driven by an energizing force (an elastic repulsive force) of the return spring. In this case, a mechanism driving by motor the rotating shaft in one direction and reverse rotating on the basis of the energizing force of the return spring (for example, the coil spring attached to the rotating shaft) itself can be executed by employing a well-known technique.

In other words, the conventional motor is structured such as to be actuated by being supplied the current by four power semiconductors for the forward rotation and the reverse rotation, and the drive circuit for switching the forward and reverse rotations. On the contrary, the motion in the reverse rotating direction is carried out by the return spring and the motor is used only in the forward rotating direction in the present embodiment. Accordingly, the power semiconductors for the reverse rotation and the switching circuit are not necessary, and the structure of the drive circuit becomes extremely simple.

Further, it is possible to control the motion in the reverse rotating direction by the return spring (not shown), that is, the throttle angle position in the closing direction by utilizing the driving force in the forward rotating direction of the motor, it is possible to control at a desired angle even in the closing motion of the throttle valve 40 on the basis of the simple structure, and it is possible to achieve an accurate engine speed without generating any delay of the control.

Further, the control by the electronic control unit 10 constructing the electronic control means of the engine speed control apparatus corresponding to the present embodiment can achieve a stable control even in a serve system in which a lot of nonlinear elements exist and a high robustness is demanded such as the engine control system, by using a robust sliding mode control in place of the PID control which has been conventionally general.

Further, since the present embodiment aims to control the rotating speed of the engine 1, it is possible to execute the control of the engine speed even if the throttle angle sensor is not provided, by feeding back only the rotating speed by the crank angle sensor 7 and devising a control algorithm in the electronic control unit 10. Accordingly, the present embodiment is structured such that the throttle angle sensor is omitted.

Next, a description will be given of details of a control content by the engine speed control apparatus in accordance with the present embodiment. The driving control of the electronic governor apparatus 4 by the electronic control unit 10 is designed as the following expressions 1 to 4, such that the engine speed comes to a target rotating speed by feeding back an input signal from the crank angle sensor 7.

$$\begin{matrix}{U}_{a} = {g}_{1} e ( t ) + {g}_{2} \int e ( t ) d t + {g}_{3} \frac{d e ( t )}{d t} + Fsign ( s ) & Expression 1 \\ s = {s}_{1} e ( t ) + {s}_{2} \dot{e} ( t ) + {s}_{3} \int e ( t ) d t & Expression 2 \\ sign ( s ) = \{ \begin{matrix}1 & if & s > 0 \\ 0 & if & s = 0 \\ - 1 & if & s < 0\end{matrix} & Expression 3 \\ e ( t ) = {N}_{d} - N & Expression 4\end{matrix}$$

In the numerical expressions mentioned above, reference symbol Uₐ denotes a drive motor control input, reference symbol N denotes an engine speed, reference symbol N_{d} denotes a target engine speed, reference symbol e(t) denotes an error with respect to the target engine speed, reference symbol F denotes a gain, and reference symbols g₁ to g₃ and s₁ to s₃ respectively denote a control parameter. Further, the control purpose by the engine speed control apparatus in accordance with the present embodiment is to control the rotating speed of the engine 1 at a fixed target value even if a load change is generated, however, a specific control procedure thereof is as follows.

When starting the engine 1, an output which is in proportion to the engine speed is output from the crank angle sensor 7, and is input as an engine speed data to the electronic control unit 10. The electronic control unit 10 carries out a computing process such that the detected engine speed comes to the target engine speed, and outputs a result thereof to the electronic governor apparatus 4 so as to control an intake air amount. Accordingly, even if the target engine speed is rapidly changed, an actual engine speed is controlled such that a steady-state error is not generated with respect to a designated target engine speed.

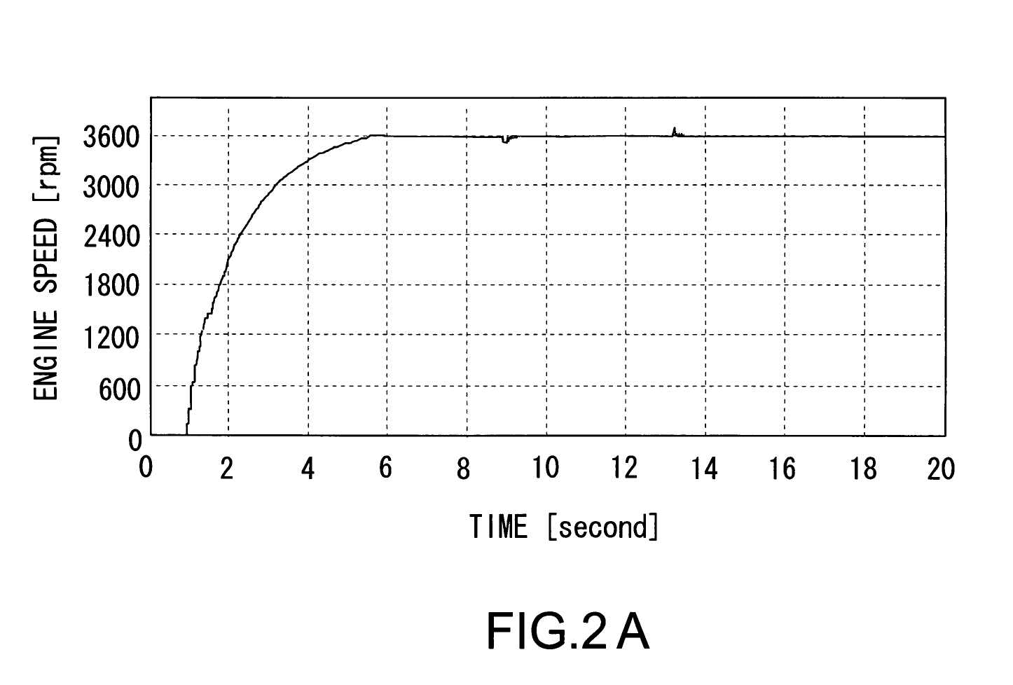

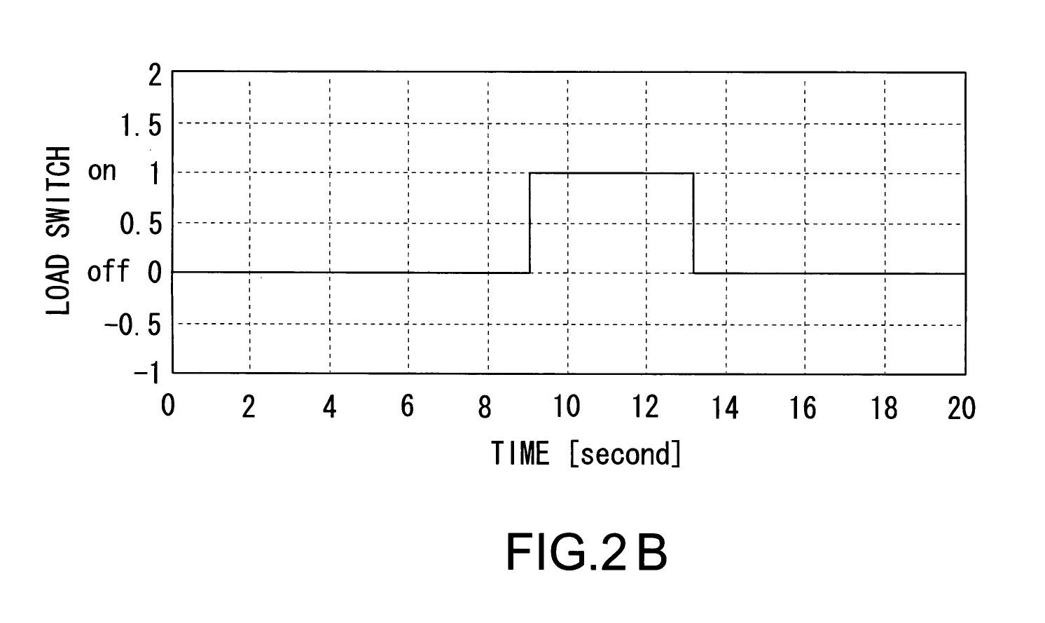

FIGS. 2A and 2B are graphs showing a result of control (a result of experiment) in accordance with the present embodiment, in which FIG. 2A shows a fluctuation of the engine speed, and FIG. 2B shows an operation state of a load switch (ON=1, OFF=0) at that time. On the basis of the result of experiment, it is known that the target engine speed is converged about 4 second from a cranking start without any overshoot, with respect to the given target engine speed, in the case that the target engine speed is 3600 rpm.

At this time, a rising edge of the engine speed becomes gentle in accordance that the target value comes close, and a very good result is obtained. If the load is input in a step manner under a condition of a load intermittent operation, an undershoot of 130 rpm (a transient rotating speed difference 2.8%) is generated, and a settling time is 0.3 second. If the load is removed inversely, an overshoot of 100 rpm (a transient rotating speed difference 3.6 a) is generated, and a settling time is 0.3 second. As mentioned above, a settling performance is extremely good, and a steady-state deviation is small at 100 rpm (a settling rotating speed difference 2.8%). Accordingly, it is confirmed that the control in accordance with the present embodiment is extremely effective.

As mentioned above, in the general purpose engine, in accordance with the present invention, it is possible to achieve the good engine speed control without increasing the cost and lowering the reliability of the apparatus.

1. An engine speed control apparatus comprising:
an electronic control means;
a throttle valve opening and closing means;
the electronic control means controlling an engine driven by feeding an air-fuel mixture to an intake passage provided with a throttle valve and a carburetor so as to maintain a predetermined engine speed by operating to open and close the throttle valve by the throttle valve opening and closing means on the basis of an engine speed detected by an engine speed detecting means and regulating an intake air amount,
wherein the throttle valve opening and closing means is formed by a motor rotationally driving the opening and closing motion of the throttle valve only in one direction, and a return spring energizing in a reverse direction to the rotation of the motor, and the throttle valve is opened and closed on the basis of a rotating force of the motor and an elastic repulsive force of the return spring.

2. An engine speed control apparatus as claimed in claim 1, wherein the throttle valve opening and closing means carries out an angle position control of the throttle valve closing motion by the return spring as well as carrying out the opening motion of the throttle valve on the basis of a turning force in a fixed direction by the motor.

3. An engine speed control apparatus as claimed in claim 1, wherein the electronic control means executes the engine speed control in accordance with a predetermined robust sliding mode control in place of the PID control.

4. An engine speed control apparatus as claimed in claim 2, wherein the electronic control means executes the engine speed control in accordance with a predetermined robust sliding mode control in place of the PID control.

5. An engine speed control apparatus as claimed in claim 3, wherein the electronic control means carries out a feedback control by using only the engine speed data detected by the electronic control means, and maintains the predetermined engine speed without using the throttle angle sensor.

6. An engine speed control apparatus as claimed in claim 4, wherein the electronic control means carries out a feedback control by using only the engine speed data detected by the electronic control means, and maintains the predetermined engine speed without using the throttle angle sensor.
